(19) United States
(12) Patent Application Publication
(10) Pub. No.: US 2019/0132033 A1
(43) Pub. Date: May 2, 2019

(54) TECHNIQUES FOR BEAM-BASED POWER CONTROL IN WIRELESS COMMUNICATIONS

(71) Applicant: QUALCOMM Incorporated, San Diego, CA (US)

(72) Inventors: Sony AKKARAKARAN, Poway, CA (US); Tao LUO, San Diego, CA (US); Xiao Feng WANG, San Diego, CA (US); Sumeeth NAGARAJA, San Diego, CA (US); Shengbo CHEN, San Diego, CA (US); Wooseok NAM, San Diego, CA (US)

(21) Appl. No.: 16/173,411

(22) Filed: Oct. 29, 2018

Related U.S. Application Data
(60) Provisional application No. 62/579,796, filed on Oct. 31, 2017.

(51) Int. Cl. H04B 7/0456; H04B 7/06; H04L 25/02; H04W 72/04; H04B 17/309

(52) U.S. Cl. CPC H04B 7/0465; H04B 7/0617; H04L 25/0224; H04L 5/005; H04W 72/046; H04W 72/0473; H04B 17/309; H04B 7/0695

(57) ABSTRACT

Aspects of the present disclosure describe transmitting beams in wireless communications. A plurality of downlink beams having different beamforming directions can be received from a base station. Downlink pathloss values associated with each of the plurality of downlink beams can be measured. A transmit power for transmitting a plurality of uplink beams can be determined based on at least one of the downlink pathloss values. The plurality of uplink beams in multiple beamformed directions can be transmitted based on the transmit power.

### CLAIM OF PRIORITY UNDER 35 U.S.C. § 119

The present application for patent claims priority to Provisional Application No. 62/579,796, entitled “TECHNIQUES FOR BEAM-BASED POWER CONTROL IN WIRELESS COMMUNICATIONS” filed Oct. 31, 2017, which is assigned to the assignee hereof and hereby expressly incorporated by reference herein for all purposes.

### BACKGROUND

Aspects of the present disclosure relate generally to wireless communication systems, and more particularly, to managing power control in transmitting wireless communications.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in 5G communications technology and beyond may be desired.

Power control for user equipment (UE) transmission power can be effectuated based on closed-loop commands (e.g., from a base station) and/or open loop parameters determined by the UE and analyzed to compute power adjustment. For example, in legacy wireless communication technologies such as long term evolution (LTE), a UE may determine a signal-to-interference-and-noise ratio (SINR), fractional pathloss, scheduled bandwidth, modulation and coding scheme (MCS), etc. associated with a received signal, and may accordingly determine a power to use in transmitting a signal to the base station or other device from which the measured signal is received. In NR, however, a given base station may transmit multiple signals from which power control parameters for the UE can be determined, which may render current mechanisms for determining power control parameters insufficient for NR technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for transmitting beams in wireless communications is provided. The method includes receiving, from a base station, a plurality of downlink beams having different beamforming directions, measuring downlink pathloss values associated with each of the plurality of downlink beams, determining, based on at least one of the downlink pathloss values, a transmit power for transmitting a plurality of uplink beams, and transmitting, based on the transmit power, the plurality of uplink beams in multiple beamformed directions.

In another example, an apparatus for wireless communication is provided that includes a transceiver, a memory configured to store instructions, and one or more processors communicatively coupled with the transceiver and the memory. The one or more processors are configured to receive, from a base station, a plurality of downlink beams having different beamforming directions, measure downlink pathloss values associated with each of the plurality of downlink beams, determine, based on at least one of the downlink pathloss values, a transmit power for transmitting a plurality of uplink beams, and transmit, based on the transmit power, the plurality of uplink beams in multiple beamformed directions.

In another example, an apparatus for transmitting beams in wireless communications is provided. The apparatus includes means for receiving, from a base station, a plurality of downlink beams having different beamforming directions, means for measuring downlink pathloss values associated with each of the plurality of downlink beams, means for determining, based on at least one of the downlink pathloss values, a transmit power for transmitting a plurality of uplink beams, and means for transmitting, based on the transmit power, the plurality of uplink beams in multiple beamformed directions.

In yet another example, a computer-readable medium, including code executable by one or more processors for transmitting beams in wireless communications, is provided. The code includes code for receiving, from a base station, a plurality of downlink beams having different beamforming directions, measuring downlink pathloss values associated with each of the plurality of downlink beams, determining, based on at least one of the downlink pathloss values, a transmit power for transmitting a plurality of uplink beams, and transmitting, based on the transmit power, the plurality of uplink beams in multiple beamformed directions.

In another example, a method for adjusting transmit power in wireless communications is provided. The method includes receiving, from a user equipment (UE), a plurality of uplink beams having different beamforming directions, measuring uplink pathloss values associated with each of the plurality of uplink beams, receiving, from the UE, one or more measured downlink pathloss values, and transmitting, to the UE and based on the uplink pathloss values and the one or more measured downlink pathloss values, a command to adjust transmit power.

In another example, an apparatus for wireless communication is provided that includes a transceiver, a memory configured to store instructions, and one or more processors communicatively coupled with the transceiver and the memory. The one or more processors are configured to receive, from a UE, a plurality of uplink beams having different beamforming directions, measure uplink pathloss values associated with each of the plurality of uplink beams, receive, from the UE, one or more measured downlink pathloss values, and transmit, to the UE and based on the uplink pathloss values and the one or more measured downlink pathloss values, a command to adjust transmit power.

In another example, an apparatus for adjusting transmit power in wireless communications is provided that includes means for receiving, from a UE, a plurality of uplink beams having different beamforming directions, means for measuring uplink pathloss values associated with each of the plurality of uplink beams, means for receiving, from the UE, one or more measured downlink pathloss values, and means for transmitting, to the UE and based on the uplink pathloss values and the one or more measured downlink pathloss values, a command to adjust transmit power.

In another example, a computer-readable medium, including code executable by one or more processors for adjusting transmit power in wireless communications, is provided. The code includes code for receiving, from a UE, a plurality of uplink beams having different beamforming directions, measuring uplink pathloss values associated with each of the plurality of uplink beams, receiving, from the UE, one or more measured downlink pathloss values, and transmitting, to the UE and based on the uplink pathloss values and the one or more measured downlink pathloss values, a command to adjust transmit power.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a base station, in accordance with various aspects of the present disclosure;

FIG. 3 is a block diagram illustrating an example of a UE, in accordance with various aspects of the present disclosure;

FIG. 4 is a flow chart illustrating an example of a method for transmitting uplink beams, in accordance with various aspects of the present disclosure;

FIG. 5 is a flow chart illustrating an example of a method for transmitting uplink beams and receiving power control commands, in accordance with various aspects of the present disclosure;

FIG. 6 is a flow chart illustrating an example of a method for receiving uplink beams, in accordance with various aspects of the present disclosure; and

FIG. 7 is a block diagram illustrating an example of a MIMO communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to associating uplink (UL) beams with downlink (DL) beams for determining a transmit power for one or more of the UL beams. For example, a user equipment (UE) can perform an UL beam-sweeping function of transmitting multiple UL beams in different beamformed directions, where each UL beam can be transmitted at a transmit power determined based at least in part on one or more DL beams received from a base station. In one example, one of the one or more DL beams (e.g., a beam having a lowest pathloss) can be used to determine the transmit power for each UL beam. In another example, each UL beam can be associated with a different received DL beam, and the associated DL beam can be used to determine the transmit power for the corresponding UL beam. In this example, the UE may also transmit pathloss measurement, or other power metrics, of the associated DL beams to allow the base station to associate the UL beams with the transmitted DL beams in an attempt to determine which UL/DL beam(s) to use in communicating with the UE.

For example, in legacy wireless communication technologies, such as long term evolution (LTE), power control for uplink channels, such as a physical uplink shared channel (PUSCH), can be performed based on closed-loop commands received from a base station and/or open loop parameters computed by the UE. For example, the open loop parameters may include signal-to-interference-and-noise ratio (SINR), fractional pathloss, scheduled bandwidth, modulation and coding scheme (MCS), etc. The determination of PUSCH power may be limited by a maximum transmit power per carrier for the UE (e.g., P_{CMAX}) and the power of the physical uplink control channel (PUCCH) (e.g., P_{PUCCH}) transmitted in the same carrier (e.g., P_{CMAX}-P_{PUCCH}). The determination of PUCCH power for the UE may be similarly determined, though parameter values and corresponding relationship to determined power may be different (e.g., PUCCH format can serve the role of scheduled bandwidth and MCS). In addition, the maximum limit for PUCCH can be P_{CMAX}. In another example, sounding reference signal (SRS) power determination can be similar to that for PUSCH power (e.g., as described above) with an additional SRS power offset added, and maximum limit can be P_{CMAX}. P_{CMAX} can be set by the UE based on configured P_{eMAX} (which can be the maximum allowed power for the UE), a power class of the UE, and/or a maximum power reduction (MPR).

In wireless communication technologies such as NR, however, power control can be beam-specific, and can thus correspond to one or more of multiple downlink beams transmitted by a base station, where each of the multiple beams may have a different pathloss. In this regard, associating each UL beam to one or more of the DL beams (e.g., for associating with a pathloss of the one or more of the DL beams) can provide a mechanism for determining power control parameters for each of the UL beams for transmitting to the base station, and/or for the base station to determine corresponding closed-loop commands for the UE based on one or more of the UL beams. In addition, in an example, SRS activation messages for activating SRS transmission at a UE can include power control parameters (e.g., absolute power control value, accumulative power control value or other parameters) for the UE, in an example.

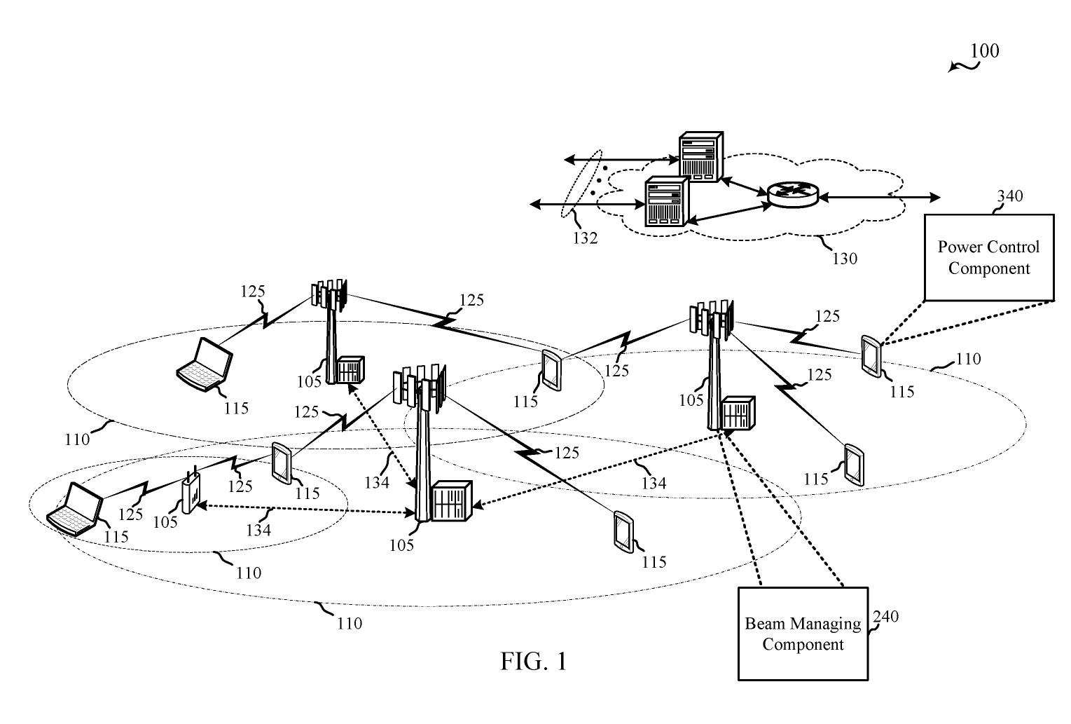

The described features will be presented in more detail below with reference to FIGS. 1-7.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to 5G networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 illustrates an example of a wireless communication system 100 in accordance with various aspects of the present disclosure. The wireless communication system 100 may include one or more base stations 105, one or more UEs 115, and a core network 130. The core network 130 may provide user authentication, access authorization, tracking, internet protocol (IP) connectivity, and other access, routing, or mobility functions. The base stations 105 may interface with the core network 130 through backhaul links 132 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with one another over backhaul links 134 (e.g., X2, etc.), which may be wired or wireless communication links.

The base stations 105 may wirelessly communicate with the UEs 115 via one or more base station antennas. Each of the base stations 105 may provide communication coverage for a respective geographic coverage area 110. In some examples, base stations 105 may be referred to as a network entity, a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communication system 100 may include base stations 105 of different types (e.g., macro or small cell base stations). There may be overlapping geographic coverage areas 110 for different technologies.

In some examples, the wireless communication system 100 may be or include a Long Term Evolution (LTE) or LTE-Advanced (LTE-A) network. The wireless communication system 100 may also be a next generation network, such as a 5G wireless communication network. In LTE/LTE-A networks, the term evolved node B (eNB), gNB, etc. may be generally used to describe the base stations 105, while the term UE may be generally used to describe the UEs 115. The wireless communication system 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs 115 with service subscriptions with the network provider.

A small cell may include a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB, gNB, etc. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A packet data convergence protocol (PDCP) layer can provide header compression, ciphering, integrity protection, etc. of IP packets. A radio link control (RLC) layer may perform packet segmentation and reassembly to communicate over logical channels. A media access control (MAC) layer may perform priority handling and multiplexing of logical channels into transport channels. The MAC layer may also use HARQ to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, an entertainment device, a vehicular component, or the like. A UE may be able to communicate with various types of base stations and network equipment including macro eNBs, small cell eNBs, relay base stations, and the like.

The communication links 125 shown in wireless communication system 100 may carry UL transmissions from a UE 115 to a base station 105, or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

In aspects of the wireless communication system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple input multiple output (MIMO) techniques that may take advantage of multi-path environments to transmit multiple spatial layers carrying the same or different coded data.

Wireless communication system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

In aspects of the wireless communication system 100, one or more of the base stations 105 may include a beam managing component 240 for transmitting one or more DL beams and/or receiving one or more UL beams from one or more UEs 115 based on the one or more DL beams. In additional aspects, UE 115 may include a power control component 340 for controlling transmit power of the UE 115 based on one or more DL beams received from one or more base stations 105, closed-loop power control commands received from the base station(s) 105, etc.

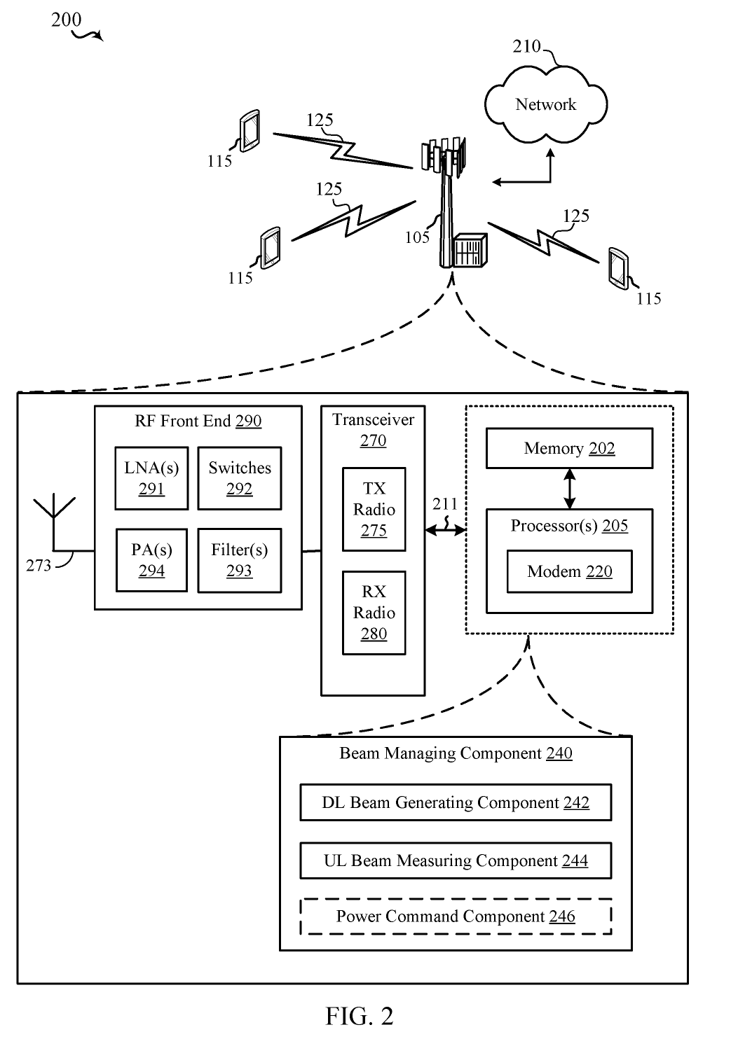

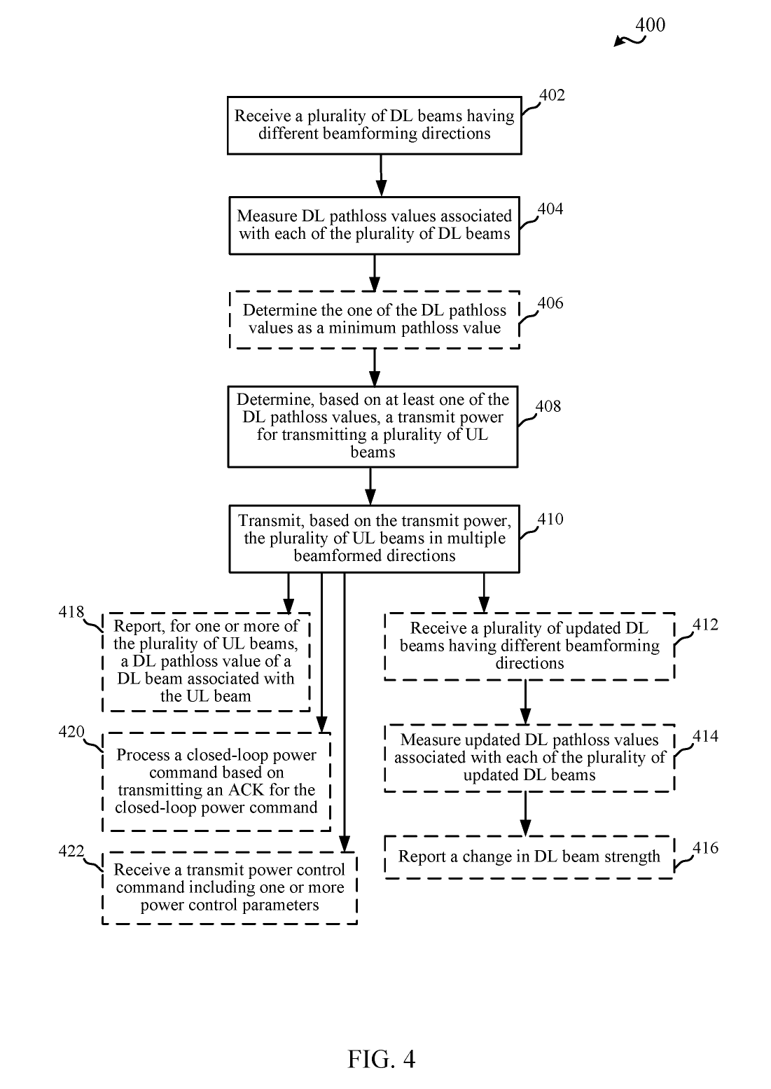

Turning now to FIGS. 2-7, aspects are depicted with reference to one or more components and one or more methods that may perform the actions or operations described herein, where aspects in dashed line may be optional. Although the operations described below in FIGS. 4-6 are presented in a particular order and/or as being performed by an example component, it should be understood that the ordering of the actions and the components performing the actions may be varied, depending on the implementation. Moreover, it should be understood that the following actions, functions, and/or described components may be performed by a specially-programmed processor, a processor executing specially-programmed software or computer-readable media, or by any other combination of a hardware component and/or a software component capable of performing the described actions or functions.

Referring to FIG. 2, a block diagram 200 is shown that includes a portion of a wireless communications system having multiple UEs 115 in communication with a base station 105 via communication links 125, where the base station 105 is also connected to a network 210. The UEs 115 may be examples of the UEs described in the present disclosure that are configured to control transmit power for one or more UL beams based on receiving DL beams. Moreover the base station 105 may be an example of the base stations described in the present disclosure (e.g., eNB, gNB, etc. providing one or more macrocells, small cells, etc.) that are configured to transmit DL beams to one or more UEs and receive UL beams from the one or more UEs.

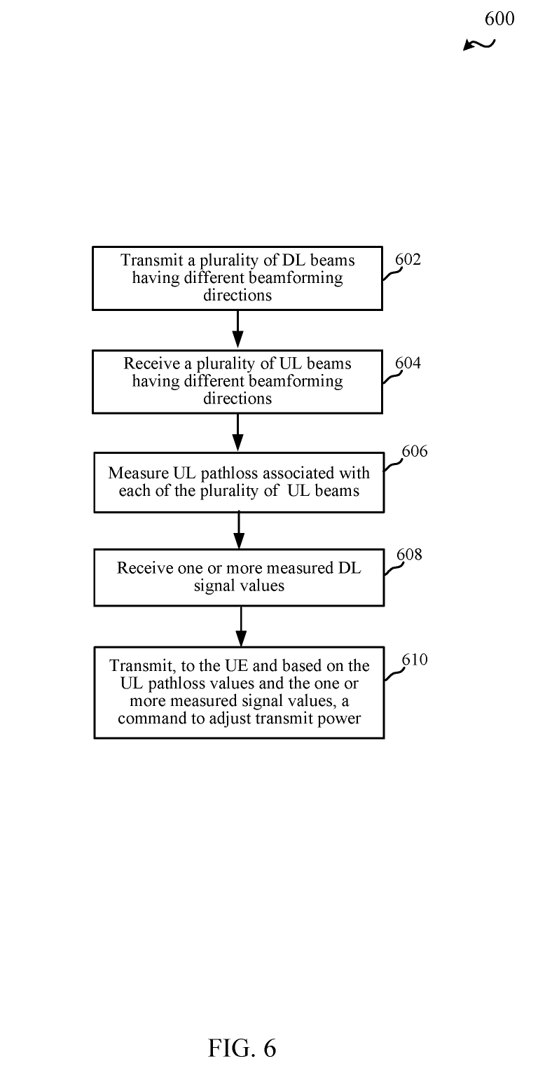

In an aspect, the base station in FIG. 2 may include one or more processors 205 and/or memory 202 that may operate in combination with a beam managing component 240 to perform the functions, methods (e.g., method 600 of FIG. 6), etc. presented in the present disclosure. In accordance with the present disclosure, the beam managing component 240 may include a DL beam generating component 242 for generating one or more DL beams for transmitting to one or more UEs, a UL beam measuring component 244 for measuring one or more parameters corresponding to UL beams transmitted by the one or more UEs, and/or an optional power command component 246 for generating and/or transmitting one or more power control commands to the one or more UEs based at least in part on the UL beams and/or DL beams.

The one or more processors 205 may include a modem 220 that uses one or more modem processors. The various functions related to the beam managing component 240, and/or its sub-components, may be included in modem 220 and/or processor 205 and, in an aspect, can be executed by a single processor, while in other aspects, different ones of the functions may be executed by a combination of two or more different processors. For example, in an aspect, the one or more processors 205 may include any one or any combination of a modem processor, or a baseband processor, or a digital signal processor, or a transmit processor, or a transceiver processor associated with transceiver 270, or a system-on-chip (SoC). In particular, the one or more processors 205 may execute functions and components included in the beam managing component 240. In another example, beam managing component 240 may operate at one or more communication layers, such as a physical layer (e.g., layer 1 (L1)), media access control (MAC) layer (e.g., layer 2 (L2)), PDCP layer or RLC layer (e.g., layer 3 (L3)), etc., to generate DL beams, measure UL beams, generate power control commands, etc.

In some examples, the beam managing component 240 and each of the sub-components may comprise hardware, firmware, and/or software and may be configured to execute code or perform instructions stored in a memory (e.g., a computer-readable storage medium, such as memory 202 discussed below). Moreover, in an aspect, the base station 105 in FIG. 2 may include a radio frequency (RF) front end 290 and transceiver 270 for receiving and transmitting radio transmissions to, for example, UEs 115. The transceiver 270 may coordinate with the modem 220 to receive signals for, or transmit signals generated by, the beam managing component 240 to the UEs. RF front end 290 may be connected to one or more antennas 273 and can include one or more switches 292, one or more amplifiers (e.g., power amplifiers (PAs) 294 and/or low-noise amplifiers 291), and one or more filters 293 for transmitting and receiving RF signals on uplink channels and downlink channels, transmitting and receiving signals, etc. In an aspect, the components of the RF front end 290 can connect with transceiver 270. The transceiver 270 may connect to one or more of modem 220 and processors 205.

The transceiver 270 may be configured to transmit (e.g., via transmitter (TX) radio 275) and receive (e.g., via receiver (RX) radio 280) wireless signals through antennas 273 via the RF front end 290. In an aspect, the transceiver 270 may be tuned to operate at specified frequencies such that the base station 105 can communicate with, for example, UEs 115. In an aspect, for example, the modem 220 can configure the transceiver 270 to operate at a specified frequency and power level based on the configuration of the base station 105 and communication protocol used by the modem 220.

The base station 105 in FIG. 2 may further include a memory 202, such as for storing data used herein and/or local versions of applications or beam managing component 240 and/or one or more of its sub-components being executed by processor 205. Memory 202 can include any type of computer-readable medium usable by a computer or processor 205, such as random access memory (RAM), read only memory (ROM), tapes, magnetic discs, optical discs, volatile memory, non-volatile memory, and any combination thereof. In an aspect, for example, memory 202 may be a computer-readable storage medium that stores one or more computer-executable codes defining beam managing component 240 and/or one or more of its sub-components. Additionally or alternatively, the base station 105 may include a bus 211 for coupling one or more of the RF front end 290, the transceiver 274, the memory 202, or the processor 205, and to exchange signaling information between each of the components and/or sub-components of the base station 105.

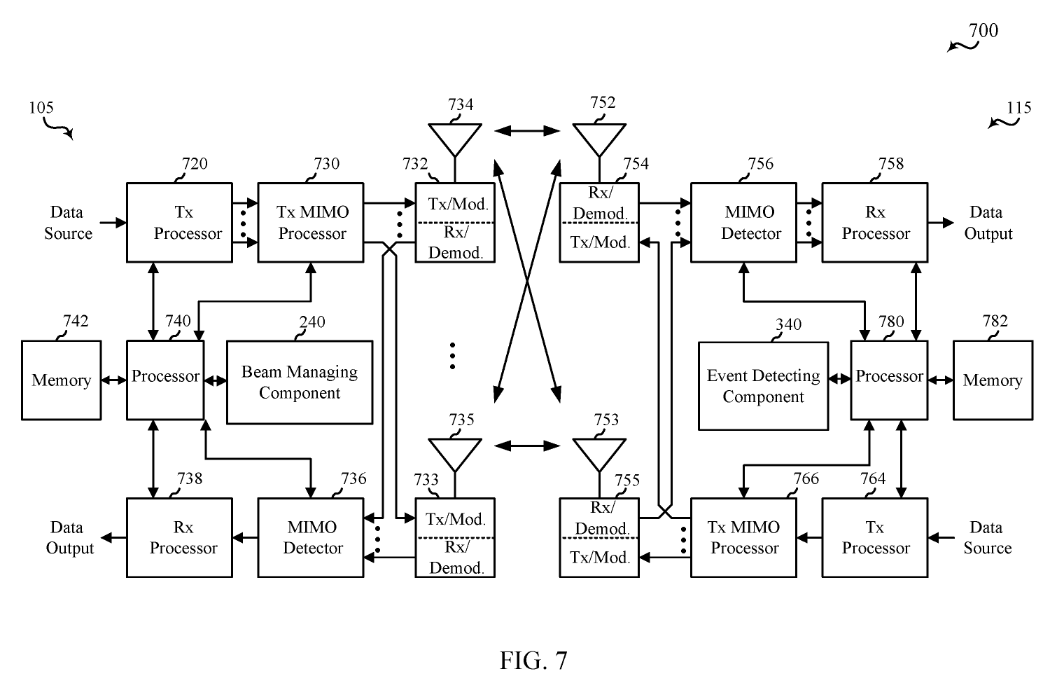

In an aspect, the processor(s) 205 may correspond to one or more of the processors described in connection with the base station in FIG. 7. Similarly, the memory 202 may correspond to the memory described in connection with the base station in FIG. 7.

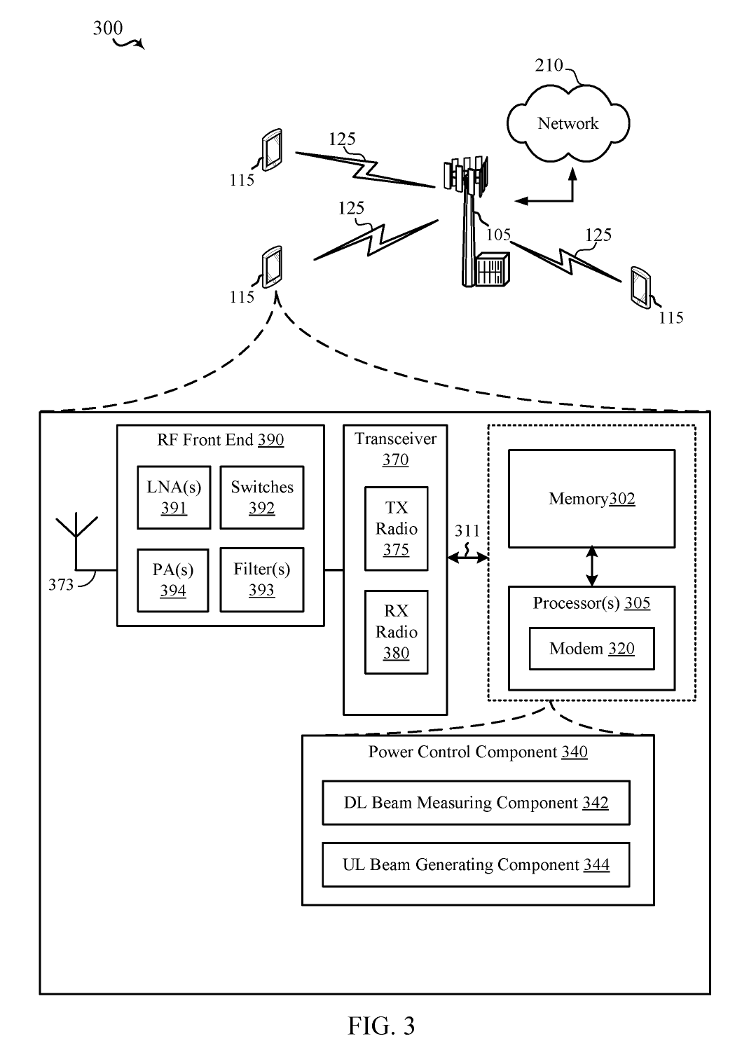

Referring to FIG. 3, a block diagram 300 is shown that includes a portion of a wireless communications system having multiple UEs 115 in communication with a base station 105 via communication links 125, where the base station 105 is also connected to a network 210. The UEs 115 may be examples of the UEs described in the present disclosure that are configured to control transmit power for one or more UL beams based on receiving DL beams. Moreover the base station 105 may be an example of the base stations described in the present disclosure (e.g., eNB, gNB, etc. providing one or more macrocells, small cells, etc.) that are configured to transmit DL beams to one or more UEs and receive UL beams from the one or more UEs.

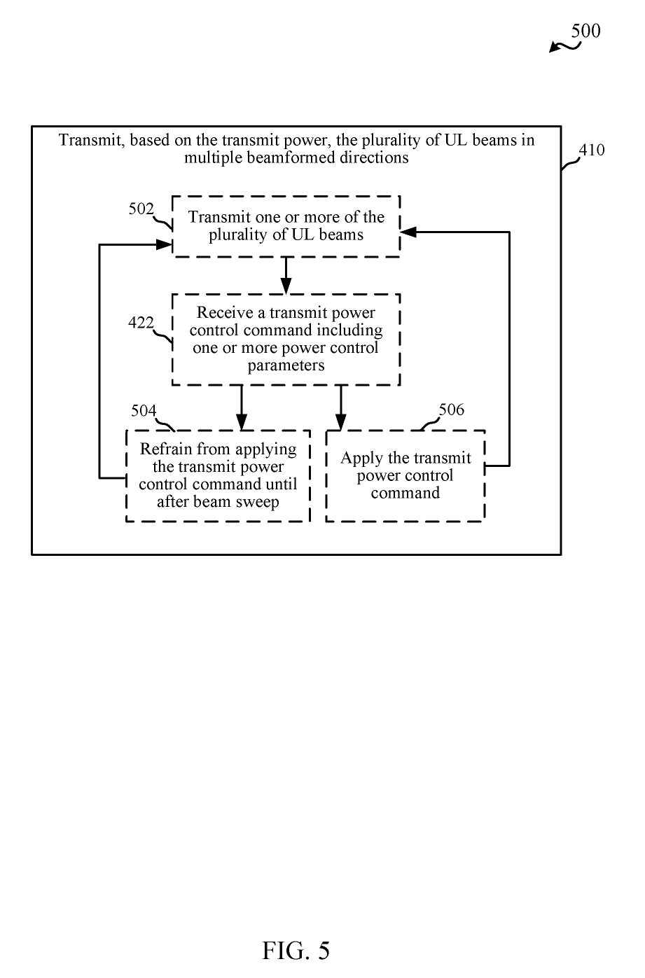

In an aspect, the UE 115 in FIG. 3 may include one or more processors 305 and/or memory 302 that may operate in combination with a power control component 340 to perform the functions, methods (e.g., method 400 of FIG. 4, method 500 of FIG. 5), etc., presented in the present disclosure. In accordance with the present disclosure, the power control component 340 may include a DL beam measuring component 342 for receiving and/or measuring one or more parameters related to DL beams from a base station 105, and/or an UL beam generating component 344 for generating and/or transmitting one or more UL beams to the base station 105, which may be based on the one or more DL beams received from the base station 105.

The one or more processors 305 may include a modem 320 that uses one or more modem processors. The various functions related to the power control component 340, and/or its sub-components, may be included in modem 320 and/or processor 305 and, in an aspect, can be executed by a single processor, while in other aspects, different ones of the functions may be executed by a combination of two or more different processors. For example, in an aspect, the one or more processors 305 may include any one or any combination of a modem processor, or a baseband processor, or a digital signal processor, or a transmit processor, or a transceiver processor associated with transceiver 370, or a system-on-chip (SoC). In particular, the one or more processors 305 may execute functions and components included in the power control component 340. In another example, power control component 340 may operate at one or more communication layers, such as physical layer or L1, MAC layer or L2, a PDCP/RLC layer or L3, etc., to measure reference signals and/or detect/report corresponding beam management events.

In some examples, the power control component 340 and each of the sub-components may comprise hardware, firmware, and/or software and may be configured to execute code or perform instructions stored in a memory (e.g., a computer-readable storage medium, such as memory 302 discussed below). Moreover, in an aspect, the UE 115 in FIG. 3 may include an RF front end 390 and transceiver 370 for receiving and transmitting radio transmissions to, for example, base stations 105. The transceiver 370 may coordinate with the modem 320 to receive signals that include packets (e.g., and/or one or more related PDUs). RF front end 390 may be connected to one or more antennas 373 and can include one or more switches 392, one or more amplifiers (e.g., PAs 394 and/or LNAs 391), and one or more filters 393 for transmitting and receiving RF signals on uplink channels and downlink channels. In an aspect, the components of the RF front end 390 can connect with transceiver 370. The transceiver 370 may connect to one or more of modem 320 and processors 305.

The transceiver 370 may be configured to transmit (e.g., via transmitter (TX) radio 375) and receive (e.g., via receiver (RX) radio 380) wireless signals through antennas 373 via the RF front end 390. In an aspect, the transceiver 370 may be tuned to operate at specified frequencies such that the UE 115 can communicate with, for example, base stations 105. In an aspect, for example, the modem 320 can configure the transceiver 370 to operate at a specified frequency and power level based on the configuration of the UE 115 and communication protocol used by the modem 320.

The UE 115 in FIG. 3 may further include a memory 302, such as for storing data used herein and/or local versions of applications or power control component 340 and/or one or more of its sub-components being executed by processor 305. Memory 302 can include any type of computer-readable medium usable by a computer or processor 305, such as RAM, ROM, tapes, magnetic discs, optical discs, volatile memory, non-volatile memory, and any combination thereof. In an aspect, for example, memory 302 may be a computer-readable storage medium that stores one or more computer-executable codes defining power control component 340 and/or one or more of its sub-components. Additionally or alternatively, the UE 115 may include a bus 311 for coupling one or more of the RF front end 390, the transceiver 374, the memory 302, or the processor 305, and to exchange signaling information between each of the components and/or sub-components of the UE 115.

In an aspect, the processor(s) 305 may correspond to one or more of the processors described in connection with the UE in FIG. 7. Similarly, the memory 302 may correspond to the memory described in connection with the UE in FIG. 7.

FIG. 4 illustrates a flow chart of an example of a method 400 for transmitting (e.g., by a UE) uplink beams to one or more base stations.

At Block 402, a plurality of DL beams having different beamforming directions can be received. In an aspect, DL beam measuring component 342, e.g., in conjunction with processor(s) 305, memory 302, transceiver 370, and/or power control component 340, can receive the plurality of DL beams (e.g., from a base station 105) having different beamforming directions. For example, the base station 105 can transmit the multiple beams as part of a beam sweeping procedure. For example, the base station 105 can generate each beam based on a different beamforming matrix, using a different phase shift, etc. to effectuate a directionality for each beam such that the base station 105 transmits, for each beam, more power in one direction than another. Using the multiple beams having multiple directionalities, for example, can allow a UE 115 receiving the multiple beams to indicate and/or select a beam to be used by the base station 105 in communicating with the UE 115 (and/or for the UE 115 to use in communicating with the base station 105) to improve quality of communications. For example, the UE 115 may experience improved signal quality in one DL beam over another, which may be based on the location of the UE 115 relative to the base station 105. For example, the UE 115 may be located more in a direction of one beam over another, may experience less obstruction, whether caused by physical environment or signal interference, of one beam over another, etc.

The beam sweeping procedure used by the base station 105 may include transmitting DL beams at different directional or angular granularities. For example, at a first instance, referred to as P1, the beam sweeping procedure may include transmitting DL beams at a first granularity and/or over a wide angular spread, where the wide angular spread can be defined by beams originating from a point at or near the base station 105 and extending in radial directions covering the spread. In this example, each DL beam can represent a beam transmitted from the base station 105 in a radial direction within the angular spread and according to the first granularity. At a second instance, referred to as P2, and based on a selected or indicated DL beam in P1 by the UE 115, the base station 105 can transmit DL beams at a second granularity and/or over a narrower angular spread to provide a more focused DL beam for the UE 115. At a third instance, referred to as P3, and based on a selected or indicated DL beam in P2 by the UE 115, the base station 105 can transmit the selected beam repeatedly to allow the UE 115 to refine its receive beam and/or measure the selected DL beam. A similar procedure can be defined for UL beam sweeping, and the instances can be respectively referred to as U1, U2, U3, in one example.

At Block 404, DL pathloss values associated with each of the plurality of DL beams can be measured. In an aspect, DL beam measuring component 342, e.g., in conjunction with processor(s) 305, memory 302, transceiver 370, power control component 340, etc., can measure the DL pathloss values associated with each of the plurality of DL beams. In other examples, DL beam measuring component 342 can measure other metrics associated with the DL beams in addition, or alternatively to, the DL pathloss, such as SINR, or other parameters received from the base station 105, such as bandwidth, MCS, etc.

Optionally, at Block 406, one of the DL pathloss values can be determined as a minimum pathloss value. In an aspect, DL beam measuring component 342, e.g., in conjunction with processor(s) 305, memory 302, transceiver 370, power control component 340, etc., can determine the one of the DL pathloss values as the minimum pathloss value. For example, DL beam measuring component 342 can compare the DL pathloss values of each of the plurality of DL beams to determine the minimum DL pathloss value. For example, the minimum DL pathloss value can indicate a desirable beam for determining a transmit power for one or more UL beams. In another example, the k-th lowest DL pathloss value, or the highest DL pathloss value not exceeding a certain threshold, can be used instead of the minimum DL pathloss value, to allow higher UL beam transmit power to ensure that more of the UL beams are received with good quality.

At Block 408, a transmit power for transmitting a plurality of UL beams can be determined based on at least one of the DL pathloss values. In an aspect, power control component 340, e.g., in conjunction with processor(s) 305, memory 302, transceiver 370, etc., can determine, based on at least one of the DL pathloss values, a transmit power for transmitting a plurality of UL beams. For example, power control component 340 may associate one of the DL beams (or at least a determined DL pathloss for the one of the DL beams) to each of the UL beams for determining a transmit power for each (e.g., all) of the UL beams. For example, in this regard, the power control component 340 can use the same DL beam for DL pathloss for all the UL beams (e.g., transmitted as part of a U1 instance of an UL beam sweeping procedure). In an example, this choice can be used in a non-reciprocal situation when there is no association between DL and UL beams. In one example, power control component 340 can use the DL pathloss determined in optional Block 406. In another example, power control component 340 can use the determined strongest DL beam (e.g., the DL beam having the lowest or minimum pathloss, as described above). Moreover, for example, power control component 340 can update measured pathloss after a complete DL beam sweep, for determining transmit power for the UL beam sweep. In an example, it may be possible that there is an update in minimum or chosen DL pathloss of DL beams during an UL beam sweep, which may complicate comparison of received strengths of UL beams transmitted before and after update. In this example, as described further herein, the UE 115 can indicate a DL beam strength change from such a beam update to the base station 105, to allow the base station 105 to make a fair comparison. In other examples, as described herein, the UE 115 can refrain from such updating of the DL beam strength (e.g., until a next beam sweep).

In another example, power control component may associate different ones of the DL beams (or associated DL pathloss values) to different ones of the UL beams. Thus, for example, power control component 340 can use different DL beam for pathloss for each UL beam (e.g., transmitted in a U1 instance of the beam sweep). In this example, each UL beam may be associated with a different DL synchronization signal (SS) block (e.g., including one or more of primary SS (PSS), secondary SS (SSS), etc.), or channel state information reference signal (CSI-RS) beams transmitted by the base station 105. More generally, a group of one or more UL beams may be associated with the same DL SS block, but different groups may be associated with different DL SS blocks. For fair comparison across U1 beams, associated DL beam strengths can be reported to the base station 105, as described further herein. For example, the UE 115 may indicate these, e.g., in L1 reference signal received power (RSRP) report. UE 115 may report absolute RSRP or RSRP differences relative to a certain DL beam. The certain DL beam, for example, may be configured through RRC or downlink control information (DCI) triggering the RSRP report or the U1 beam sweep. For example, this may allow even weak beams to be received with enough power at base station 105. In addition, this can provide good channel sounding, while still maintaining fair comparison across UL beams.

Though described in terms of U1 beams, similar procedures can be applied for U2 beam sweeping procedures as well. For example, in U2 beam sweeping, the UE 115 can transmit refined beams that can be received with the same base station receive beam. For example, the base station receive beam can be based on the best beam identified in U1 beam sweep, as described above. If these beams are associated with corresponding DL beams (e.g., CSI-RS beams), again each beam power may be based on corresponding DL pathloss. As in U1 beam sweep, UE RSRP reports can be included to let the base station 105 do fair comparison across U2 beams. For simplicity, or absent such beam association, all U2 beam powers may be based on the same DL beam (e.g., the strongest or most desirable DL beam in the P2 beam sweep, as described above) for DL pathloss measurement, as described above in another example.

At Block 410, the plurality of UL beams can be transmitted in multiple beamformed directions. In an aspect, UL beam generating component 344, e.g., in conjunction with processor(s) 305, memory 302, transceiver 370, power control component 340, etc., can transmit, based on the transmit power, the plurality of UL beams in the multiple beamformed directions. For example, UL beam generating component 344 can transmit the UL beams at the transmit power determined based on the single DL pathloss of the single DL beam, at different transmit powers based on multiple associated DL pathloss of corresponding DL beams, etc. In this example, UL beam generating component 344 may transmit one or more UL beams per received DL beam. In addition, for example, UL beam generating component 344 can apply a beamforming matrix, phase shift, etc. to each of the plurality of UL beams to effectuate transmitting the UL beams in different beamformed directions, as described. In one example, UL beam generating component 344 may determine the beamforming for the UL beams based on beamformed directions received, determined, or estimated for the corresponding DL beams, beamformed directions configured in the UE 115 (e.g., based on configured beamforming matrices), etc. Moreover, for example, the transmitted UL beams can correspond to a known waveform, such as a SRS. Transmitting multiple UL beams in a beam sweeping procedure can help to identify good UL beams when UL/DL channel reciprocity does not exist, can be used as an alternative to DL beam sweeping (P1 procedure) when reciprocity holds, etc.

Optionally, at Block 412, a plurality of updated DL beams having different beamforming directions can be received, and optionally, at Block 414, updated DL pathloss values associated with each of the plurality of updated DL beams can be measured. In an aspect, DL beam measuring component 342, e.g., in conjunction with processor(s) 305, memory 302, transceiver 370, power control component 340, etc., can receive the plurality of updated DL beams having the different beamforming directions and/or can measure the updated DL pathloss values associated with each of the plurality of updated DL beams. As described, for example, such updates may hinder transmit power control as it may change which DL beam is used for determining the transmit power for all UL beams. In this example, power control component 340 may refrain from processing DL pathloss updates until after the UL beam sweep procedure is complete (e.g., once all UL beams have been transmitted). In another example, optionally, at Block 416, a change in DL beam strength can be reported. In an aspect, DL beam measuring component 342, e.g., in conjunction with processor(s) 305, memory 302, transceiver 370, power control component 340, etc., can report (e.g., to the base station 105) the change in DL beam strength, which can be consider by the base station 105 in determining the DL beam used in determining transmit power for corresponding UL beams.

Optionally, at Block 418, a DL pathloss value of a DL beam associated with the UL beam can be reported for one or more of the plurality of UL beams. In an aspect, DL beam measuring component 342, e.g., in conjunction with processor(s) 305, memory 302, transceiver 370, power control component 340, etc., can report, for one or more of the plurality of UL beams, a DL pathloss value of the DL beam associated with the UL beam. In one example, this can include reporting the DL pathloss of a single beam associated with one or more (e.g., each) of the UL beams. In another example, this can include reporting the DL pathloss value of a DL beam associated with each of the UL beams (e.g., where each UL beam is associated with a different DL beam). For example, DL beam measuring component 342 can report the plurality of DL pathloss values where each UL beam is associated with a different DL beam, in the example described above. In any case, this can allow the base station 105 to determine correlation between the UL beams and DL beams (or associated pathloss values) for determining closed-loop transmit power commands for the UE. In one example, DL beam measuring component 342 can report at least one of an absolute value of one of the downlink pathloss values, a relative difference value of the downlink pathloss values as compared to a reference pathloss value, etc.

Furthermore, optionally, at Block 420, a closed-loop power command can be processed based on transmitting an acknowledgement (ACK) for the closed-loop power command. In an aspect, power control component 340, e.g., in conjunction with processor(s) 305, memory 302, transceiver 370, etc., can process the closed-loop power command based on transmitting the ACK for the closed-loop power command. As described, for example, transmit power update for UL beam sweeping (e.g., whether U1, U2, or U3), whether caused by a determined update to DL pathloss (e.g., based on DL beam pathloss) or based on received closed-loop power commands, may span a power control time boundary, such as a slot (e.g., which may include a number of orthogonal frequency division multiplexing (OFDM) symbols, DFT-spread orthogonal frequency division multiplexing (DFT-s-OFDM) symbols, and/or the like). In this case, as described in other examples, the power control component 340 can skip or postpone an update (e.g., at least until the UL beam sweeping procedure completes). In another example, the update may be applied provided the base station 105 is aware of it, which may include power control component 340 updating transmit power based on closed-loop adjustment (accumulative or absolute) transmitted by the base station 105, but possibly not for DL pathloss changes, or allow updates based on DL pathloss changes if they are reported to the base station 105, e.g., using RSRP reports, as described above. In another example, power control component 340 can update transmit power if the UE 115 is able to transmit the ACK acknowledging receipt of the update from the base station 105 (e.g., using PUCCH or PUSCH, if update came with DL or UL grant respectively), and/or if UE is determined to be outside of a threshold from a power headroom limit (e.g., so that update is not limited by headroom, as base station 105 may not know of this limitation)).

In another example, optionally at Block 422, a transmit power control command including one or more power control parameters can be received. In an aspect, power control component 340, e.g., in conjunction with processor(s) 305, memory 302, transceiver 370, etc., can receive the transmit power control command including the one or more power control parameters, and can accordingly modify transmit power for one or more uplink communications based on the one or more power control commands. In one example, power control component 340 can receive the transmit power control command in response to the transmitted UL beams transmitted in Block 410. In one example, power control component 340 can receive the transmit power control command as an SRS activation message for activating an SRS channel or other resources, which can also include the one or more power control parameters. The SRS activation message can be received from the base station 105 over RRC, DCI, etc. Moreover, for example, the SRS activation message may include parameters such as an SRS power offset, and absolute or accumulative power control command, etc. Moreover, in an example, power control component 340 can use the SRS power offset for each SRS transmission. An absolute power control command may be a further offset used e.g., only once or over a limited number of SRS transmissions. An accumulative command may be a power offset that is added to such commands received previously (and/or accumulated across multiple SRS activations), either during previous SRS activations/deactivations or while an SRS resource was previously active.

FIG. 5 illustrates a flow chart of an example of a method 500 for transmitting (e.g., by a UE) uplink beams to one or more base stations. Method 500 can include a plurality of optional Blocks that can be performed as part of transmitting UL beams as described in Block 410 in method 400 of FIG. 4.

At Block 410, the plurality of UL beams can be transmitted in multiple beamformed directions. In an aspect, UL beam generating component 344, e.g., in conjunction with processor(s) 305, memory 302, transceiver 370, power control component 340, etc., can transmit, based on the transmit power, the plurality of UL beams in the multiple beamformed directions, as described above. Transmitting the plurality of UL beams at Block 410 may optionally include, at Block 502, transmitting one or more of the plurality of UL beams. In an aspect, UL beam generating component 344, e.g., in conjunction with processor(s) 305, memory 302, transceiver 370, power control component 340, etc., can transmit the one or more of the plurality of UL beams (e.g., a portion of the UL beams). This can include UL beam generating component 344 transmitting the one or more of the plurality of UL beams as part of the beam sweeping procedure.

Transmitting the plurality of UL beams at Block 410 may optionally include, at Block 422, receiving a transmit power control command including one or more power control parameters. In an aspect, power control component 340, e.g., in conjunction with processor(s) 305, memory 302, transceiver 370, etc., can receive the transmit power control command including the one or more power control parameters, as described. For example, power control component 340 can receive the power control command from the base station 105, in reference to transmitted UL beams that correspond to one or more received DL beams, etc., as described. Moreover, in an example, the transmit power control command can include a closed-loop power command. For example, power control component 340 can receive the power control command (or multiple power control commands) during the beam sweep procedure (e.g., before all of the plurality of UL beams have been transmitted). In this case, power control component 340 can either apply the transmit power control command or refrain from applying the power control command for at least a period of time or based on detecting an event.

Thus, in one example, transmitting the plurality of UL beams at Block 410 may optionally include, at Block 504, refraining from applying the transmit power control command until after beam sweep. In an aspect, power control component 340, e.g., in conjunction with processor(s) 305, memory 302, transceiver 370, etc., can refrain from applying the transmit power control command until after beam sweep. As described, applying the transmit power control command before the beam sweep is completed may result in unfair comparison of the beams at the base station 105 (unless the base station 105 is aware that the transmit power control command is applied, such as by sending an ACK thereto, as described). In this example, power control component 340 can refrain from applying the transmit power control command at least until the UL beam sweep is completed, which may include power control component 340 detecting the end of the UL beam sweep and accordingly applying one or more received (and unapplied) transmit power control commands for subsequently transmitting signals (e.g., data signals, beams, etc.) to the base station 105 and/or other network nodes. In an example, refraining from applying the transmit power control command can include skipping applying of the command altogether (e.g., ignoring the command), postponing applying of the command until a point in time or based on detecting occurrence of an event (which may include functions related to detecting the point in time or occurrence of the event), etc.

In this example, after refraining from applying the transmit power control command, at Block 504, transmitting the plurality of UL beams at Block 410 can include, at Block 502, transmitting one or more of the plurality of UL beams. In an aspect, UL beam generating component 344, e.g., in conjunction with processor(s) 305, memory 302, transceiver 370, power control component 340, etc., can transmit the one or more of the plurality of UL beams, which may include one or more of a remaining portion of the UL beams until all UL beams are transmitted and/or until another transmit power control command is received at Block 422.

In another example, transmitting the plurality of UL beams at Block 410 may optionally include, at Block 506, applying the transmit power control command. In an aspect, power control component 340, e.g., in conjunction with processor(s) 305, memory 302, transceiver 370, etc., can apply the transmit power control command, which can include adjusting a transmit power for one or more of the UL beams, as described. In addition, in this example, power control component 340 may transmit an ACK of receiving and/or applying the transmit power control command.

In this example, after applying the transmit power control command, at Block 506, transmitting the plurality of UL beams at Block 410 can include, at Block 502, transmitting one or more of the plurality of UL beams. In an aspect, UL beam generating component 344, e.g., in conjunction with processor(s) 305, memory 302, transceiver 370, power control component 340, etc., can transmit the one or more of the plurality of UL beams at the adjusted transmit power, which may include one or more of a remaining portion of the UL beams until all UL beams are transmitted and/or until another transmit power control command is received at Block 422.

FIG. 6 illustrates a flow chart of an example of a method 600 for receiving UL beams from a UE (e.g., by a base station 105, which can include a gNB, eNB, etc., as described).

In method 600, at Block 602, a plurality of DL beams having different beamforming directions can be transmitted. In an aspect, DL beam generating component 242, e.g., in conjunction with processor(s) 205, memory 202, transceiver 270, and/or beam managing component 240, can transmit the plurality of DL beams having the different beamforming directions. As described, DL beam generating component 242 can generate the DL beams by applying a beamforming matrix, phase shift, etc. to achieve a directional power for the beam. In addition, this can be part of a DL beam sweeping procedure, such as P1, P2, P3, etc., as described. A UE 115 can receive the DL beams and use the DL beams to determine power control adjustments based on open-loop parameters determined from one or more of the DL beams, as described.

At Block 604, a plurality of UL beams having different beamforming directions can be received. In an aspect, UL beam measuring component 244, e.g., in conjunction with processor(s) 205, memory 202, transceiver 270, and/or beam managing component 240, etc. can receive the plurality of UL beams having the different beamforming directions. For example, as described, the plurality of UL beams may be generated using a beamforming matrix, phase shift, etc. to achieve the directional power and/or may be based on the beamforming determined for one or more corresponding DL beams. In another example, as described, the UE 115 can transmit the plurality of UL beams based on a determined DL pathloss of one or more of the DL beams (e.g., using a transmit power determined based on the DL pathloss, indicating a DL beam to which the UL is associated, etc.). The received UL beams can be detected based on a known waveform, such as an SRS.

At Block 606, UL pathloss associated with each of the plurality of UL beams can be measured. In an aspect, UL beam measuring component 244, e.g., in conjunction with processor(s) 205, memory 202, transceiver 270, beam managing component 240, etc. can measure UL signal quality or pathloss associated with each of the plurality of UL beams. For example, this can assist in determining a desired UL beam for subsequent uplink communications from the UE 115 (e.g., a UL beam determined to have the lowest pathloss). Moreover, UL beam measuring component 244 may determine a UL beam identifier in the UL beam to facilitate indicating the desired UL beam back to the UE 115, in one example.

At Block 608, one or more measured DL signal values can be received. In an aspect, beam managing component 240, e.g., in conjunction with processor(s) 205, memory 202, transceiver 270, etc. can receive the one or more measured DL signal values, which may include a measured signal quality, RSRP, pathloss, etc. In one example, the UE 115 can report the DL signal values to the base station 105 to assist in determining a desired DL beam and/or corresponding UL beam. In addition, in an example, power command component 246 may generate a power command for the UE 115 based at least in part on the one or more received DL pathloss values and/or the measured UL signal quality values.

At Block 610, a command to adjust transmit power can be transmitted to the UE based on the UL signal quality or pathloss values and the one or more measured signal values. In an aspect, power command component 246, e.g., in conjunction with processor(s) 205, memory 202, transceiver 270, beam managing component 240, etc. can transmit, to the UE 115 and based on the UL pathloss values and the one or more measured signal values, the command to adjust transmit power. For example, power command component 246 can determine the transmit power for the UE 115 based generally on uplink quality that can be measured and/or the received DL signal values (e.g., signal quality, RSRP, pathloss, etc.). Thus, in one example, power command component 246 can determine the DL beam (and/or DL pathloss) associated with one or more of the UL beams, such as an UL beam determined to have a lowest pathloss, and can accordingly determine power commands for the UE 115 based on the UL beam with the lowest pathloss. In one example, power command component 246 can also use the corresponding reported DL pathloss to determine the transmit power command for the UE 115. For multiple uplink beams, in an example, power command component 246 can determine and transmit power control commands for each of the UL beams, or may transmit a common command applying all UL beams.

In one example, power command component 246 can transmit the power command in a SRS activation message, as described. Furthermore, in an example, beam managing component 240 may receive an updated DL pathloss measurement value from the UE 115, and power command component 246 can use the updated DL pathloss measurement in generating the transmit power command (e.g., based on fair comparison of UL beams generated based on original or updated DL pathloss measurements). In another example, power command component 246 can determine whether to use updated DL pathloss values based on whether an ACK for a closed-loop power command is received from the UE 115, as described. Moreover, in an example, beam managing component 240 can determine and/or indicate a UL beam, as described, to the UE 115 to use in communicating with the base station 105, which may be based on the measured UL pathloss and/or a reported DL pathloss for a corresponding DL beam.

FIG. 7 is a block diagram of a MIMO communication system 700 including a base station 105 and a UE 115. The MIMO communication system 700 may illustrate aspects of the wireless communication system 100 described with reference to FIG. 1. The base station 105 may be an example of aspects of the base station 105 described with reference to FIGS. 1-3. The base station 105 may be equipped with antennas 734 and 735, and the UE 115 may be equipped with antennas 752 and 753. In the MIMO communication system 700, the base station 105 may be able to send data over multiple communication links at the same time. Each communication link may be called a “layer” and the “rank” of the communication link may indicate the number of layers used for communication. For example, in a 2×2 MIMO communication system where base station 105 transmits two “layers,” the rank of the communication link between the base station 105 and the UE 115 is two.

At the base station 105, a transmit (Tx) processor 720 may receive data from a data source. The transmit processor 720 may process the data. The transmit processor 720 may also generate control symbols or reference symbols. A transmit MIMO processor 730 may perform spatial processing (e.g., precoding) on data symbols, control symbols, or reference symbols, if applicable, and may provide output symbol streams to the transmit modulator/demodulators 732 and 733. Each modulator/demodulator 732 through 733 may process a respective output symbol stream (e.g., for OFDM, etc.) to obtain an output sample stream. Each modulator/demodulator 732 through 733 may further process (e.g., convert to analog, amplify, filter, and upconvert) the output sample stream to obtain a DL signal. In one example, DL signals from modulator/demodulators 732 and 733 may be transmitted via the antennas 734 and 735, respectively.

The UE 115 may be an example of aspects of the UEs 115 described with reference to FIGS. 1-3. At the UE 115, the UE antennas 752 and 753 may receive the DL signals from the base station 105 and may provide the received signals to the modulator/demodulators 754 and 755, respectively. Each modulator/demodulator 754 through 755 may condition (e.g., filter, amplify, downconvert, and digitize) a respective received signal to obtain input samples. Each modulator/demodulator 754 through 755 may further process the input samples (e.g., for OFDM, etc.) to obtain received symbols. A MIMO detector 756 may obtain received symbols from the modulator/demodulators 754 and 755, perform MIMO detection on the received symbols, if applicable, and provide detected symbols. A receive (Rx) processor 758 may process (e.g., demodulate, deinterleave, and decode) the detected symbols, providing decoded data for the UE 115 to a data output, and provide decoded control information to a processor 780, or memory 782.

The processor 780 may in some cases execute stored instructions to instantiate a power control component 340 (see e.g., FIGS. 1 and 3).

On the uplink (UL), at the UE 115, a transmit processor 764 may receive and process data from a data source. The transmit processor 764 may also generate reference symbols for a reference signal. The symbols from the transmit processor 764 may be precoded by a transmit MIMO processor 766 if applicable, further processed by the modulator/demodulators 754 and 755 (e.g., for SC-FDMA, etc.), and be transmitted to the base station 105 in accordance with the communication parameters received from the base station 105. At the base station 105, the UL signals from the UE 115 may be received by the antennas 734 and 735, processed by the modulator/demodulators 732 and 733, detected by a MIMO detector 736 if applicable, and further processed by a receive processor 738. The receive processor 738 may provide decoded data to a data output and to the processor 740 or memory 742.

The processor 740 may in some cases execute stored instructions to instantiate a beam managing component 240 (see e.g., FIGS. 1 and 2).

The components of the UE 115 may, individually or collectively, be implemented with one or more ASICs adapted to perform some or all of the applicable functions in hardware. Each of the noted modules may be a means for performing one or more functions related to operation of the MIMO communication system 700. Similarly, the components of the base station 105 may, individually or collectively, be implemented with one or more ASICs adapted to perform some or all of the applicable functions in hardware. Each of the noted components may be a means for performing one or more functions related to operation of the MIMO communication system 700.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for transmitting beams in wireless communications, comprising:
receiving, from a base station, a plurality of downlink beams having different beamforming directions;
measuring downlink pathloss values associated with each of the plurality of downlink beams;
determining, based on at least one of the downlink pathloss values, a transmit power for transmitting a plurality of uplink beams; and
transmitting, based on the transmit power, the plurality of uplink beams in multiple beamformed directions.

2. The method of claim 1, wherein determining the transmit power for transmitting each of the plurality of uplink beams is based on one of the downlink pathloss values.

3. The method of claim 2, further comprising determining the one of the downlink pathloss values as a minimum pathloss value of the plurality of downlink beams.

4. The method of claim 2, further comprising, after transmitting the plurality of uplink beams:
receiving, from the base station, a plurality of updated downlink beams having different beamforming directions;
measuring updated downlink pathloss values associated with each of the plurality of updated downlink beams.

5. The method of claim 4, further comprising reporting, to the base station, a change in downlink beam strength between one or more of the plurality of downlink beams and one or more of the plurality of updated downlink beams.

6. The method of claim 1, further comprising refraining from updating a determination of the transmit power based on at least one of measuring updated downlink pathloss values or processing closed-loop power commands received from the base station until each of a set of uplink beams, comprising the plurality of uplink beams, is transmitted.

7. The method of claim 1, further comprising receiving, in response to transmitting at least one of the plurality of uplink beams, a sounding reference signal (SRS) resource activation message including one or more power control parameters.

8. The method of claim 7, wherein the SRS resource activation message includes at least one of a SRS power offset, an absolute power control value, or an accumulative power control value.

9. The method of claim 8, wherein the accumulative power control value is accumulated across multiple SRS activations and/or SRS transmissions.

10. The method of claim 7, further comprising adjusting the transmit power and transmitting a SRS based at least in part on the one or more power control parameters.

11. The method of claim 1, wherein determining the transmit power for transmitting each of the plurality of uplink beams is based on a different one of the downlink pathloss values.

12. The method of claim 11, wherein the plurality of downlink beams include synchronization signal block beams or channel state information reference signal beams.

13. The method of claim 11, further comprising reporting, to the base station and for each of the plurality of uplink beams, the different one of the downlink pathloss values associated to the uplink beam.

14. The method of claim 13, wherein reporting the different one of the downlink pathloss values comprise reporting at least one of an absolute value of the different one of the downlink pathloss values, or a relative difference value of the different one of the downlink pathloss values as compared to a reference pathloss value.

15. The method of claim 1, further comprising processing one or more closed-loop power commands received from the base station during transmitting of the plurality of uplink beams based at least in part on transmitting an acknowledgement of the one or more closed-loop power commands to the base station.

16. An apparatus for wireless communication, comprising:
a transceiver;
a memory configured to store instructions; and
one or more processors communicatively coupled with the transceiver and the memory, wherein the one or more processors are configured to:
receive, from a base station, a plurality of downlink beams having different beamforming directions;
measure downlink pathloss values associated with each of the plurality of downlink beams;
determine, based on at least one of the downlink pathloss values, a transmit power for transmitting a plurality of uplink beams; and
transmit, based on the transmit power, the plurality of uplink beams in multiple beamformed directions.

17. The apparatus of claim 16, wherein the one or more processors are configured to determine the transmit power for transmitting each of the plurality of uplink beams based on one of the downlink pathloss values.

18. The apparatus of claim 17, wherein the one or more processors are further configured to determine the one of the downlink pathloss values as a minimum pathloss value of the plurality of downlink beams.

19. The apparatus of claim 17, wherein the one or more processors are configured to, after transmitting the plurality of uplink beams:
receive, from the base station, a plurality of updated downlink beams having different beamforming directions;
measure updated downlink pathloss values associated with each of the plurality of updated downlink beams.

20. The apparatus of claim 19, wherein the one or more processors are further configured to report, to the base station, a change in downlink beam strength between one or more of the plurality of downlink beams and one or more of the plurality of updated downlink beams.

21. The apparatus of claim 16, wherein the one or more processors are configured to refrain from updating a determination of the transmit power based on at least one of measuring updated downlink pathloss values or processing closed-loop power commands received from the base station until each of a set of uplink beams, comprising the plurality of uplink beams, is transmitted.

22. The apparatus of claim 16, wherein the one or more processors are configured to receive, in response to transmitting at least one of the plurality of uplink beams, a sounding reference signal (SRS) resource activation message including one or more power control parameters.

23. The apparatus of claim 22, wherein the SRS resource activation message includes at least one of a SRS power offset, an absolute power control value, or an accumulative power control value.

24. The apparatus of claim 23, wherein the accumulative power control value is accumulated across multiple SRS activations and/or SRS transmissions.

25. The apparatus of claim 22, wherein the one or more processors are configured to adjust the transmit power and transmit a SRS based at least in part on the one or more power control parameters.

26. An apparatus for transmitting beams in wireless communications, comprising:
means for receiving, from a base station, a plurality of downlink beams having different beamforming directions;
means for measuring downlink pathloss values associated with each of the plurality of downlink beams;
means for determining, based on at least one of the downlink pathloss values, a transmit power for transmitting a plurality of uplink beams; and
means for transmitting, based on the transmit power, the plurality of uplink beams in multiple beamformed directions.

27. The apparatus of claim 26, wherein the means for determining determines the transmit power for transmitting each of the plurality of uplink beams based on one of the downlink pathloss values.

28. The apparatus of claim 27, further comprising means for determining the one of the downlink pathloss values as a minimum pathloss value of the plurality of downlink beams.

29. The apparatus of claim 26, further comprising means for refraining from updating a determination of the transmit power based on at least one of measuring updated downlink pathloss values or processing closed-loop power commands received from the base station until each of a set of uplink beams, comprising the plurality of uplink beams, is transmitted.

30. A computer-readable medium, comprising code executable by one or more processors for transmitting beams in wireless communications, the code comprising code for:
receiving, from a base station, a plurality of downlink beams having different beamforming directions;
measuring downlink pathloss values associated with each of the plurality of downlink beams;
determining, based on at least one of the downlink pathloss values, a transmit power for transmitting a plurality of uplink beams; and
transmitting, based on the transmit power, the plurality of uplink beams in multiple beamformed directions.

31. The computer-readable medium of claim 30, wherein the code for determining determines the transmit power for transmitting each of the plurality of uplink beams based on one of the downlink pathloss values.

32. The computer-readable medium of claim 31, further comprising code for determining the one of the downlink pathloss values as a minimum pathloss value of the plurality of downlink beams.

33. The computer-readable medium of claim 30, further comprising code for refraining from updating a determination of the transmit power based on at least one of measuring updated downlink pathloss values or processing closed-loop power commands received from the base station until each of a set of uplink beams, comprising the plurality of uplink beams, is transmitted.

34. A method for adjusting transmit power in wireless communications, comprising:
receiving, from a user equipment (UE), a plurality of uplink beams having different beamforming directions;
measuring uplink pathloss values associated with each of the plurality of uplink beams;
receiving, from the UE, one or more measured downlink pathloss values; and
transmitting, to the UE and based on the uplink pathloss values and the one or more measured downlink pathloss values, a command to adjust transmit power.

35. The method of claim 34, wherein receiving, from the UE, one or more measured downlink pathloss values comprises receiving one downlink pathloss value, and wherein transmitting the command is based on the uplink pathloss values and the one downlink pathloss value.

36. The method of claim 35, wherein the one downlink pathloss value is associated with a change from a previously measured downlink pathloss value.

37. The method of claim 34, wherein the command to adjust transmit power comprises a sounding reference signal (SRS) resource activation message including one or more power control parameters.

38. The method of claim 37, wherein the SRS resource activation message includes at least one of a SRS power offset, an absolute power control value, or an accumulative power control value.

39. The method of claim 34, wherein receiving, from the UE, one or more measured downlink pathloss values comprises receiving one downlink pathloss value for each of the plurality of uplink beams.

40. The method of claim 39, wherein transmitting the command to adjust power is based at least in part on comparing the one or more measured downlink pathloss values for each of the plurality of uplink beams to a corresponding uplink pathloss value.

41. An apparatus for wireless communication, comprising:
a transceiver;
a memory configured to store instructions; and
one or more processors communicatively coupled with the transceiver and the memory, wherein the one or more processors are configured to:
receive, from a user equipment (UE), a plurality of uplink beams having different beamforming directions;
measure uplink pathloss values associated with each of the plurality of uplink beams;
receive, from the UE, one or more measured downlink pathloss values; and
transmit, to the UE and based on the uplink pathloss values and the one or more measured downlink pathloss values, a command to adjust transmit power.

42. The apparatus of claim 41, wherein the one or more processors are configured to receive the one or more measured downlink pathloss values as one downlink pathloss value, and wherein the one or more processors are configured to transmit the command based on the uplink pathloss values and the one downlink pathloss value.

43. The apparatus of claim 42, wherein the one downlink pathloss value is associated with a change from a previously measured downlink pathloss value.

44. The apparatus of claim 41, wherein the command to adjust transmit power comprises a sounding reference signal (SRS) resource activation message including one or more power control parameters.

45. An apparatus for adjusting transmit power in wireless communications, comprising:
means for receiving, from a user equipment (UE), a plurality of uplink beams having different beamforming directions;
means for measuring uplink pathloss values associated with each of the plurality of uplink beams;
means for receiving, from the UE, one or more measured downlink pathloss values; and
means for transmitting, to the UE and based on the uplink pathloss values and the one or more measured downlink pathloss values, a command to adjust transmit power.

46. The apparatus of claim 45, wherein the means for receiving the one or more measured downlink pathloss values receives one downlink pathloss value, and wherein the means for transmitting transmits the command based on the uplink pathloss values and the one downlink pathloss value.

47. The apparatus of claim 46, wherein the one downlink pathloss value is associated with a change from a previously measured downlink pathloss value.

48. A computer-readable medium, comprising code executable by one or more processors for adjusting transmit power in wireless communications, the code comprising code for:
receiving, from a user equipment (UE), a plurality of uplink beams having different beamforming directions;
measuring uplink pathloss values associated with each of the plurality of uplink beams;
receiving, from the UE, one or more measured downlink pathloss values; and
transmitting, to the UE and based on the uplink pathloss values and the one or more measured downlink pathloss values, a command to adjust transmit power.

49. The computer-readable medium of claim 48, wherein the code for receiving the one or more measured downlink pathloss values receives one downlink pathloss value, and wherein the code for transmitting transmits the command based on the uplink pathloss values and the one downlink pathloss value.

50. The computer-readable medium of claim 49, wherein the one downlink pathloss value is associated with a change from a previously measured downlink pathloss value.
